(19) United States
(12) Patent Application Publication
(10) Pub. No.: US 2011/0227860 A1
(43) Pub. Date: Sep. 22, 2011

(54) RESISTIVE TOUCH SCREEN

(76) Inventors: Ho Joon Park, Seoul (KR); Yong Soo Oh, Gyunggi-do (KR); Sang Hwa Kim, Gyunggi-do (KR); Kyoung Soo Chae, Gyunggi-do (KR); Hee Bum Lee, Gyunggi-do (KR); Jong Young Lee, Gyunggi-do (KR)

(21) Appl. No.: 12/787,926

(22) Filed: May 26, 2010

(30) Foreign Application Priority Data
Mar. 22, 2010 (KR) 10-2010-0025374

(51) Int. Cl. G06F 3/045

(52) U.S. Cl. 345/174

(57) ABSTRACT

Disclosed herein is a resistive touch screen, including: a large-area touch screen formed by connecting two or more single touch screens, each including a first substrate and a second substrate which are respectively coated with transparent electrodes on one side thereof and face each other, on the same level; a plurality of first dot spacers formed on first connection parts at which the first substrates are connected with each other and supporting second connection parts at which the second substrates are connected with each other; and a plurality of second dot spacers formed on respective one sides of the first substrates excluding the first connection parts and having a lower height than the plurality of first dot spacers. The resistive touch screen is advantageous in that a large-area touch panel can be realized by connecting single touch panels on the same level.

### CROSS REFERENCE TO RELATED APPLICATION

This application claims the benefit of Korean Patent Application No. 10-2010-0025374, filed Mar. 22, 2010, entitled “Resistive touch screen”, which is hereby incorporated by reference in its entirety into this application.

### BACKGROUND OF THE INVENTION

1. Technical Field

The present invention relates to a resistive touch screen.

2. Description of the Related Art

Along with the development of computers using digital technology, computer peripherals have been developed together with the computers. Personal computers, portable transmitters and other information equipment conduct text processing and graphic processing using various input devices such as keyboards, mice and the like.

In conjunction with the rapid progress in the information society, the range of available computer applications is expanding. However, there is a problem in that keyboards and mice, serving as input devices, find it difficult to efficiently operate computers. Therefore, there is a requirement to develop input devices which can easily operate, which do not malfunction and which can easily input data by any user.

Further, input devices are required to have high reliability, durability, originality, design and machinability as well as to satisfy general functions. For this reason, a touch screen, as an input device capable of inputting information such as text, graphics and the like, was developed.

The touch screen is provided on the display surface of electronic organizers, liquid crystal displays (LCDs), plasma display panels (PDPs), electroluminescent displays (ELDs), cathode ray tubes (CRT) and the like, and is used to allow users to select desired information.

Touch screens are classified into resistive touch screens, capacitive touch screens, electromagnetic touch screens, surface acoustic wave (SAW) type touch panels, and infrared touch screens. The various types of touch screens are employed in electronic products in consideration of the problems of signal amplifications, differences in resolution, difficulties in design and machining technologies, optical characteristics, electrical characteristics, mechanical characteristics, environmental characteristics, input characteristics, durability and economic efficiency. Among the various touch screens, resistive touch screens and capacitive touch screens are the most widely used.

Among the above types of touch screens, a resistive touch screen is configured such that two substrates coated with a transparent electrode face each other and a dot spacer is disposed therebetween. Referring to the operating procedure of a resistive touch screen, when users touch a resistive touch screen, an upper substrate is bent, so that the transparent electrodes respectively applied on the upper and lower substrates are brought into contact with each other, with the result that the voltages applied to the transparent electrodes are changed, thereby detecting the touched position of the resistive touch screen by measuring the change of voltages. The resistive touch screen is advantageous in that it can be easily fabricated at a low cost because it has a simple structure.

However, the resistive touch screen is problematic in that its upper substrate is repeatedly bent whenever it is touched, so that it is sagged, with the result that it cannot be fabricated in a large area.

### SUMMARY OF THE INVENTION

Accordingly, the present invention has been made to solve the above-mentioned problems, and the present invention provides a resistive touch screen which can prevent its upper substrate from being sagged by employing relatively high and dense dot spacers while connecting single touch panels to realize a large area touch panel.

An aspect of the present invention provides a resistive touch screen, including: a large-area touch screen formed by connecting two or more single touch screens, each including a first substrate and a second substrate which are respectively coated with transparent electrodes on one side thereof and face each other, on the same level; a plurality of first dot spacers formed on first connection parts at which the first substrates are connected with each other and supporting second connection parts at which the second substrates are connected with each other; and a plurality of second dot spacers formed on respective one sides of the first substrates excluding the first connection parts and having a lower height than the plurality of first dot spacers.

Here, the distance between the plurality of first dot spacers may be narrower than the distance between the plurality of second dot spacers.

Further, the thickness of the plurality of first dot spacers may be greater than the thickness of the plurality of second dot spacers.

Further, the curvature radius of the end of the plurality of first dot spacers may be greater than the curvature radius of the end of the plurality of second dot spacers.

Further, the transparent electrodes may be made of a conductive polymer.

Further, the conductive polymer may be selected from among poly-3,4-ethylenedioxythiophene/polystyrenesulfonate (PEDOT/PSS), polyaniline, polyacetylene and polyphenylenevinylene.

Further, the resistive touch screen may further include: a display panel having the same size as the large-area touch panel and formed on the other side of the first substrates using an adhesive layer.

Further, the adhesive layer may be formed on a third connection part at which the first substrates are connected with each other.

Further, the adhesive layer may be formed of optical clear adhesive (OCA).

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a resistive touch screen according to an embodiment of the present invention;

FIG. 2 is a perspective view showing a first substrate provided with first dot spacers and second dot spacers according to an embodiment of the present invention; and

FIGS. 3A and 3B are sectional views comparing a first dot spacer and a second dot spacer according to an embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side,” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a preferred embodiment of the present invention will be described in detail with reference to the attached drawings.

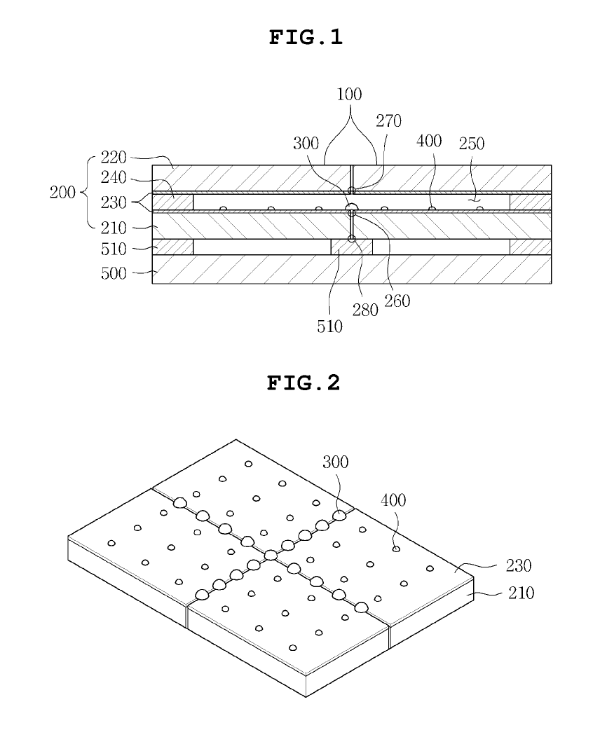

FIG. 1 is a sectional view showing a resistive touch screen according to an embodiment of the present invention, and FIG. 2 is a perspective view showing a first substrate provided with first dot spacers and second dot spacers according to an embodiment of the present invention.

As shown in FIGS. 1 and 2, the resistive touch screen according to an embodiment of the present invention includes: a large-area touch screen 100 formed by connecting two or more single touch screens 200, each including a first substrate 210 and a second substrate 220 which are respectively coated with transparent electrodes 230 on one side thereof and face each other, on the same level; a plurality of first dot spacers 300 formed on first connection parts 260 at which the first substrates 210 are connected with each other and supporting second connection parts 270 at which the second substrates 220 are connected with each other; and a plurality of second dot spacers 400 formed on respective one sides of the first substrates 210 excluding the first connection parts 260 and having a lower height than the plurality of first dot spacers 300.

The two or more single touch panels 200 are connected with each other to form a large-area touch panel 100, and each of the single touch panels 200 may be fabricated in a predetermined size (for example, 19 inches or more) in order to prevent the substrates from being sagged by repetitive touching. Here, each of the single touch panels 200 has a structure in which a first substrate 210 and a second substrate 220 face each other in a state in which an air gap 250 is formed therebetween by double-sided adhesive tape, and the first substrate 210 and the second substrate 220 are coated on their respective one sides with transparent electrodes 230, respectively. Therefore, when a user touches the second substrate 220, the second substrate is bent, so that the transparent electrodes 230 respectively formed on the first substrate 210 and the second substrate 220 are brought into contact with each other, with the result that the voltages applied to the transparent electrodes 230 are changed, thereby detecting the touched positions by measuring the change of voltages.

Meanwhile, methods of forming a large-area touch panel 100 by connecting two or more single touch panels 200 with each other are not particularly limited, but the large-area touch panel 100 may be realized by attaching the lateral sides of the single touch panels 200 to each other using optical clear adhesive (OCA) or double-sided adhesive tape.

Further, the first substrate 210 and the second substrate 220 may be made of polyethylene terephthalate (PET), polycarbonate (PC), polymethylmethacrylate (PMMA), polyethylene naphthalate (PEN), polyether sulfone (PES), cycloolefin copolymer (COC), triacetylcellulose (TAC) film, polyvinyl alcohol (PVA) film, polyimide (PI) film, polystyrene (PS), K-resin-containing biaxially-oriented polystyrene (BOPS), glass, reinforced glass or the like. Meanwhile, the transparent electrodes applied on one side of the first substrate 210 and one side of the second substrate 220 may be made of conductive polymers having excellent flexibility and coatability as well as commonly-used indium tin oxide (ITO). Here, examples of the conductive polymers may include poly-3,4-ethylenedioxythiophene/polystyrenesulfonate (PEDOT/PSS), polyaniline, polyacetylene, polyphenylenevinylene and the like.

Further, before one side of the first substrate 210 and one side of the second substrate 220 are coated with the transparent electrodes 230, one side of the first substrate 210 and one side of the second substrate 220 may be treated with high frequency waves or may be primer-treated in order to improve the surface activity (adhesivity).

The plurality of first dot spacers 300 are formed on first connection parts 260 of the first substrates 210, and serve to support the second connection parts 270 of the second substrates 220. In the resistive touch screen of the present invention, the large-area touch panel 100 is formed by connecting small-sized single touch panels 200 in order to prevent the sagging of the upper substrates, which occurs when the resistive touch screen is fabricated using a large-area substrate. However, the parts at which the single touch panels 200 are connected with each other (particularly, the second connection parts 270 of the second substrates 220 which can be bent and simultaneously sagged or cracked when it is touched by a user) are relatively low in terms of structural stability. Therefore, the second connection parts 270 at which the second substrates 220 are connected with each other can be stably supported by forming the plurality of first dot spacers 300 on the first connection parts 260 at which the first substrates 210 are connected with each other.

Hereinafter, the first dot spacer 300 will be described in more detail with reference to the accompanying drawings.

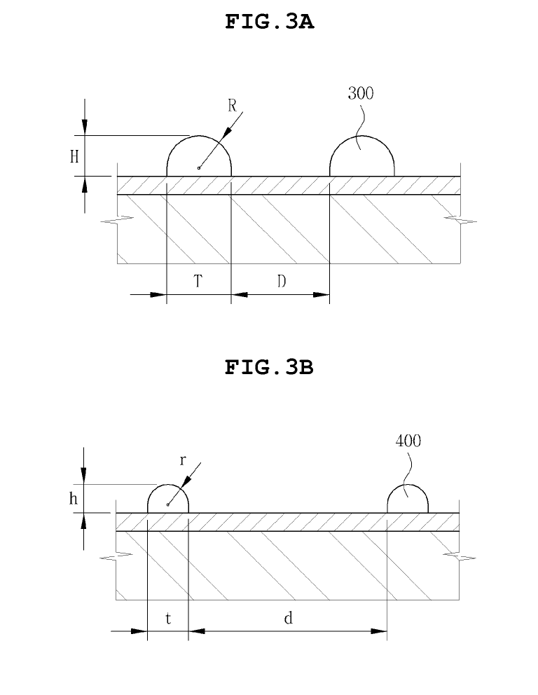

FIGS. 3A and 3B are sectional views comparing a first dot spacer and a second dot spacer according to an embodiment of the present invention. As shown in FIGS. 3A and 3B, in order to allow the first dot spacer 300 to support the second connection part 270 in a stronger way, the height (H) of the first dot spacer 300 may be greater than the height (h) of the second dot spacer 400 which is a general dot spacer, and the thickness (T) of the first dot spacer 300 may be greater than the thickness (t) of the second dot spacer 400.

Further, the distance (D) between the first dot spacers 300 is smaller than the distance (d) between the second dot spacers 400 to make the first dot spacers 300 dense, and the curvature radius (R) of the end of the first dot spacer 300 is greater than the curvature radius (r) of the end of the second dot spacer 400 to increase the contact area of the first dot spacer 300 and the second substrate 220, thus strengthening the supporting force of the first dot spacer 300 to the second connection part 270.

As described above, the resistive touch screen according to the present invention can prevent the second connection parts 270 of the second substrates 220 from being sagged or cracked, occurring when single touch panels 200 are connected with each other to realize a large-area touch panel 100, by employing the first dot spacers 300 having an excellent supporting force.

The plurality of second dot spacers 400, which are general dot spacers as described above, serve to alleviate the impact between the first substrate 210 and the second substrate 220 when a user touches the second substrate 220, to provide a repulsive force allowing the second substrate 220 to return to its original position when the pressure applied to the second substrate 220 by the user is removed, and thus to maintain the insulation between the first substrate 210 and the second substrate 220. Therefore, the second dot spacers 400 may have elasticity, and may be made of transparent materials such that the images outputted from a display panel 500 to be described later are not blocked by the second dot spacers 400.

Meanwhile, a display panel 500 having the same size as the large-area touch panel 200 is formed on the other side of the first substrates 210 using an adhesive layer 510 (refer to FIG. 1). Here, the display panel 500 serves to output the images, and examples thereof may include liquid crystal displays (LCDs), plasma display panels (PDPs), electroluminescent displays (ELDs), cathode ray tubes (CRT) and the like. Further, the adhesive layer 510 may be made of a transparent material, for example, an optical clear adhesive (OCA), such that it does not prevent users from recognizing the images outputted from the display panel 500. Further, the adhesive layer is formed at the edge of the large-area touch panel 100 to attach the display panel 500 to the large-area touch panel 100. In this case, in order to ensure the structural stability of the interconnected first substrates 210, the adhesive layer 510 may be formed even on the third connection part 280 at which the first substrates 210 are connected with each other.

As described above, the resistive touch screen of the present invention is advantageous in that a large-area touch panel can be realized by connecting single touch panels on the same level.

Further, the resistive touch screen of the present invention is advantageous in that its upper substrate can be stably supported by forming relatively high and dense dot spacers on the connection parts at which the single touch panels are connected with each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A resistive touch screen, comprising:
a large-area touch screen formed by connecting two or more single touch screens, each including a first substrate and a second substrate which are respectively coated with transparent electrodes on one side thereof and face each other, on the same level;
a plurality of first dot spacers formed on first connection parts at which the first substrates are connected with each other and supporting second connection parts at which the second substrates are connected with each other; and
a plurality of second dot spacers formed on respective one sides of the first substrates excluding the first connection parts and having a lower height than the plurality of first dot spacers.

2. The resistive touch screen according to claim 1, wherein the distance between the plurality of first dot spacers is narrower than the distance between the plurality of second dot spacers.

3. The resistive touch screen according to claim 1, wherein the thickness of the plurality of first dot spacers is greater than the thickness of the plurality of second dot spacers.

4. The resistive touch screen according to claim 1, wherein the curvature radius of the end of the plurality of first dot spacers is greater than the curvature radius of the end of the plurality of second dot spacers.

5. The resistive touch screen according to claim 1, wherein the transparent electrodes are made of a conductive polymer.

6. The resistive touch screen according to claim 5, wherein the conductive polymer is selected from among poly-3,4-ethylenedioxythiophene/polystyrenesulfonate (PEDOT/PSS), polyaniline, polyacetylene, and polyphenylenevinylene.

7. The resistive touch screen according to claim 1, further comprising: a display panel having the same size as the large-area touch panel and formed on the other side of the first substrates using an adhesive layer.

8. The resistive touch screen according to claim 7, wherein the adhesive layer is formed on a third connection part at which the first substrates are connected with each other.

9. The resistive touch screen according to claim 7, wherein the adhesive layer is formed of optical clear adhesive (OCA).
